(19) United States
(12) Patent Application Publication
(10) Pub. No.: US 2006/0190230 A1
(43) Pub. Date: Aug. 24, 2006

(54) Method and apparatus for cross simulation data sharing to facilitate higher resolution data measurements for complex designs

(76) Inventors: Sylvia D. Patterson, Fort Collins, CO (US); Robert A. Zimmer, Loveland, CO (US)

Correspondence Address: AVAGO TECHNOLOGIES, LTD., P.O. BOX 1920, DENVER, CO, 80201-1920, US

(21) Appl. No.: 11/065,401

(22) Filed: Feb. 24, 2005

(51) Int. Cl. G06F 17/50

(52) U.S. Cl. 703/14

(57) ABSTRACT

A method and apparatus is presented for performing simulation of complex circuits. A circuit is simulated in a fast simulator. State information, which is the output of the fast simulator, is translated in a translator and then the circuit is simulated in a slow simulator. In one embodiment, the circuit is modeled in a digital format in the fast simulator and modeled in an analog format in the slow simulator.

### BACKGROUND OF THE INVENTION

### Description of the Related Art

Modern electronics, computers, and communications related processors include a large number of circuits. The shear volume of circuits requires that software tools are used to manage the design, development, and implementation of these processors.

A variety of software tools are used to implement modern day processors. Among these software tools are software tools for planning the layout of the processor, software tools for planning the cost associated with the processor, and software tools that simulate the processor.

Given the large number of circuits in a modern processor, the software tools that simulate these circuits take on an important role in conventional circuit design. Software simulation may be used to perform an initial design, optimize a design, troubleshoot a design, etc. and, as such, reduces the time and cost associated with implementing large-scale circuit designs.

However, as the scale of modern day circuits increases, the complexity and time required to simulate these circuits also increases. For example, to accurately simulate a circuit, a representation of the circuit must be implemented in a simulator and the more complex the circuit the longer the simulation takes.

Thus, there is a need for a simple, cost-effective method and apparatus for simulating circuits.

### SUMMARY OF THE INVENTION

In accordance with the teachings of the present invention, a method and apparatus for simulating circuits, complex circuits, and/or large-scale circuits is presented.

A method of simulating comprises the steps of modeling a circuit in a fast simulator and generating an output; generating a translated output by translating the output; and modeling the circuit in a slow simulator in response to generating a translated output.

A method of simulating, comprises the steps of modeling a variable under investigation in a digital format; generating an output by simulating the variable under investigation in the digital format; translating the output to an analog format; and modeling the variable under investigation in the analog format.

A method of investigating a circuit variable, comprising the steps of simulating a digital model of a circuit thereby producing digital state information; transforming the digital state information to analog state information; and simulating an analog model of the circuit in response to transforming the digital state information to the analog state information.

### BRIEF DESCRIPTION OF THE DRAWINGS

FIG. 1 displays an architecture implemented in accordance with the teachings of the present invention.

FIG. 2 displays a flow diagram implementing the teachings of the present invention.

FIG. 3 displays a hardware architecture implemented in accordance with the teachings of the present invention.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

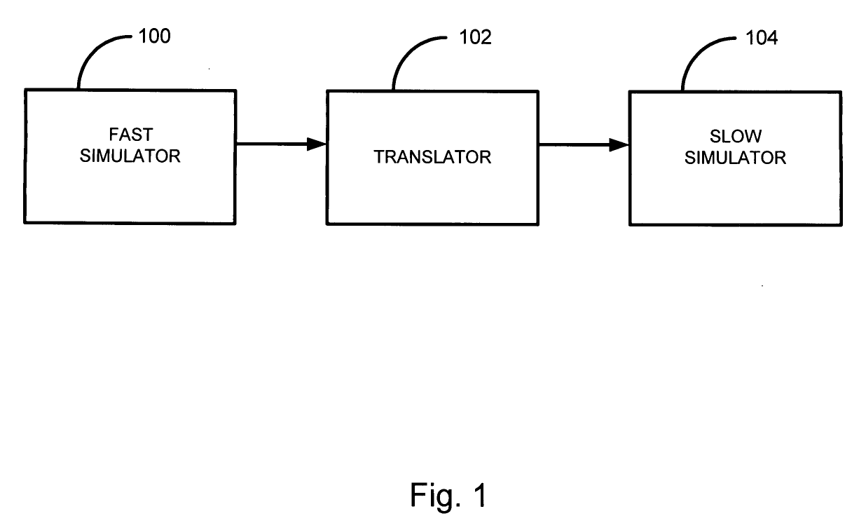

FIG. 1 displays an architecture implemented in accordance with the teachings of the present invention. In one embodiment of the present invention, a fast simulator 100 is implemented to perform a fast simulation of a circuit, such as a large-scale circuit or a mixed signal system. In one embodiment, a fast simulator 100 includes software and/or hardware that may be used to implement a digital model of a circuit (i.e., digital format). For example, a circuit may be implemented using a fast simulation tools, such as The Verilog hardware description language (Institute for Electronic & Electrical Engineers 1364-2005).

In one embodiment, a simulation of a circuit under study is run in a fast simulator 100. State information associated with the circuit is then translated using a translator 102. In one embodiment, the translator 102 is defined as software and/or hardware that may be used to translate an output from the fast simulator 100 to a format that is usable by a slow simulator 104.

In accordance with the teachings of the present invention, a slow simulator 104 is implemented to perform a simulation of a circuit, such as a large-scale circuit. In one embodiment, the slow simulator 104 includes software and/or hardware that may be used to implement an analog model (i.e., representation) of the variables (i.e., states) associated with a circuit (i.e., analog format). For example, a circuit may be implemented using a slow simulation tools, such as The SPICE software simulation tool, a registered trademark of Cadence Design Systems, Inc. The simulation may then continue until the variables (i.e., states, etc.) associated with the circuit can be assessed. It should be appreciated that although the fast simulator 100, the translator 102, and the slow simulator 104 are shown separately, they may each operate independently, collectively, or in different permutations and combinations.

During operation, in one embodiment of the present invention, a circuit is identified. A simulation is required to investigate a specific variable (i.e., state) in a specific location of the circuit. Under normal simulation conditions, the variable in question (i.e., variable under investigation) in the location in question would not become apparent until the simulation is run for some time (i.e., there is a long initialization period). In accordance with the teachings of the present invention, the circuit is first simulated in the fast simulator 100, translated using the translator 102, and the circuit is then simulated in the slow simulator 104 to determine the outcome of the variable in question.

In one embodiment, the simulation in the fast simulator 100 includes representing the variables under investigation in a digital format or digital representation in a simulator. For example, if a voltage on a node is the variable under investigation, a 0 or 1 representation is an example of a digital representation of the variable under investigation. Predefined conditions are implemented to identify the point at which the simulator should terminate:

Once the simulation is terminated in the fast simulator 100, all of the state information (i.e., output of the fast simulator 100) is translated using the translator 102. In one embodiment of the present invention, the translation in the translator 102, assumes that all the variables under investigation have been resolved in the fast simulator 100 and there are no variables that are in an indeterminate state. The translator 102 then transforms the digital representation of the variable (i.e., 0 or 1) to an analog representation of the variable. For example, if the variable under investigation is a voltage with a range of 0 to 1.4 volts, the 0 in the digital representation would be transformed to a 0 in the analog representation. The 1 in the digital representation would be transformed to a 1.4 in the analog representation. Lastly, as part of the transformation performed by the translator 102, the state information from the fast simulator 100 (i.e., output) is organized for input into the slow simulator 104 as initial conditions.

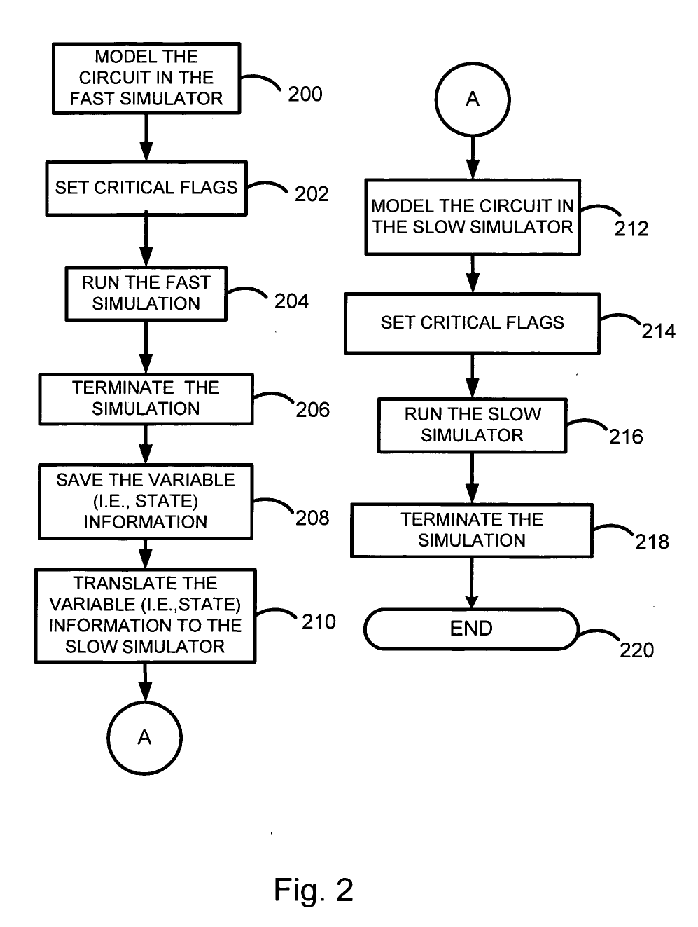

FIG. 2 displays a flow diagram implementing the teachings of the present invention. In one embodiment, there is a need to investigate a variable associated with a circuit. The variable is an analog variable, meaning that the variable has a range of values. For example, voltage values or current values are examples of analog variables. In addition, there is a long initialization period before the variable in question in the location in question can be realized.

In accordance with the teachings of the present invention, the circuit is modeled in a fast simulator, such as a digital simulator, as stated at 200. In one embodiment, the digital simulator is a simulator in which variables may have a value of 0 or 1. For example, the circuit may be represented in the Verilog language. Although, the simulation is performed to investigate an analog problem, the circuit under investigation is initially modeled for simulation in the digital simulator. For example, a cell, such as an AND gate, may be represented in the digital simulator. For the purposes of discussion, assume that the voltage (i.e., an analog variable) on one of the inputs to the AND gate is the variable under investigation (i.e., herein referred to as the “AND gate variable”). In accordance with the teachings of the present invention, the AND gate variable would be represented in a digital simulator. In addition, as part of the simulation, critical flags are set as stated at 202 and the fast simulation is run as stated at 204. The flags define when the AND gate variable has reached a predefined threshold, value, etc. Once the flag is triggered, the fast simulation is terminated as stated at 206. As stated at 208, once the fast simulation is terminated, all of the relevant state information is stored. The output of the fast simulator is then translated for use in the slow simulator as stated at 210.

In one embodiment, the output of the fast simulator may include all of the information required to continue the simulation in the slow simulator. For example, the output of the fast simulator may include information on all or some of the cells in the circuit under study, information on all or some of the variables in the circuit under study, interrelationships between some or all of the cells or variables under study, etc. In one embodiment, the translation includes changing the output of the fast simulator to an output that will operate with the slow simulator. The translation may include partially or fully modeling the circuit for use in the slow simulator, defining different variables output from the fast simulator as initial conditions for the slow simulator, introducing new variables required in the slow simulator, etc.

The circuit is then modeled in the slow simulator as stated at 212. In one embodiment, modeling the circuit for use in the slow simulator includes using the variables saved as output from the fast simulator to provide the initial conditions for the circuit model (i.e., representation) in the slow simulator. At step 214, critical flags are set to observe particular points of interest (i.e., variables) in the circuit. For example, using the foregoing example, the AND gate variable (i.e., analog voltage value on the input to the AND gate) may be flagged since this was the state in question at the beginning of the analysis. At 216, the slow simulation is then performed. The slow simulation is performed until the critical flag is triggered. When the critical flag is triggered, the simulation is terminated as stated at 218. The method then ends as stated at 220. Once the critical flag is triggered, an analysis may be made of the variable in question. Using the foregoing example, an analysis may be made of the voltage on the input to the AND gate in our example.

In one embodiment of the present invention, the fast simulator is run until the simulation converges. In one embodiment, convergence implies a scenario where the circuit is operating at steady-state (i.e., in the simulation) and/or the variable in question is determinate. A number of alternative embodiments may be implemented to cause the simulation to converge. In accordance with the teachings of the present invention, there is a one-to-one mapping between the model of the circuit in the fast simulator and the model of the circuit in the slow simulator. As such, the simulation in the fast simulator will converge.

In a second scenario, there is no one-to-one mapping between the model in the fast simulator and the model in the slow simulator. In accordance with the teachings of the present invention, when there is no one-to-one mapping or a partial one-to-one mapping between the model of the circuit in the fast simulator and the model of the circuit in the slow simulator, the model of the circuit is defined at the most detailed level using the simulation tool. Modeling at the most detailed level includes characterizing as many nodes, states, etc. as feasible to represent the circuit under investigation. In some circuits, this may mean modeling 80 percent of the nodes, in other circuits this may mean modeling 40 percent of the nodes in a very detailed way and then modeling the remainder of the circuit in a less detailed way. It should be appreciated that a number of computations and permutations of modeling scenarios may be implemented to model the circuit at the most detailed level feasible for the given simulation and the variables under investigation. In one embodiment, Verilog may be used to model the circuit at the most detailed level possible to perform the simulation in the fast simulator (i.e., digital model representation). As such, the simulation has the greatest chance of converging when transferred to the slow simulator (i.e., analog model representation).

In a third embodiment, the circuit under simulation includes cells with internal nodes. For example, a combinational logic circuit, sequential logic circuit, a flip-flop, etc, may include cells with internal nodes. As such, the model of the circuit in the fast simulator may be different from the model of the circuit in the slow simulator. For example, the slow simulator may model each of the internal nodes in a cell while the fast simulator may not model the internal nodes in the cell.

In accordance with the teachings of the present invention, in the scenario where the circuit under simulation has cells with internal nodes, the simulation is allowed to run for a period of time until the internal nodes and the cells within the circuit reach steady state, converge, and/or reach a determinate state. As a result, the simulation has the greatest change of convergence in the slow simulator.

In a fourth embodiment, the circuit under simulation is modeled in the slow simulator using cells with internal nodes. As such, the internal nodes do not have direct exposure to the translated states (i.e., initial conditions generated by the fast simulator) outside of the cells. In this scenario, the cells, such as flip-flops, may have states on the internal nodes that conflict with the states on the external nodes.

In accordance with the teachings of the present invention, in this fourth scenario where the circuit under simulation has cells with internal nodes that conflict with the states on the external nodes, the simulation is allowed to run for a period of time until the internal nodes and the cells within the circuit reach steady state, converge, and/or reach a determinate state. As a result, the simulation has the greatest change of convergence in the slow simulator.

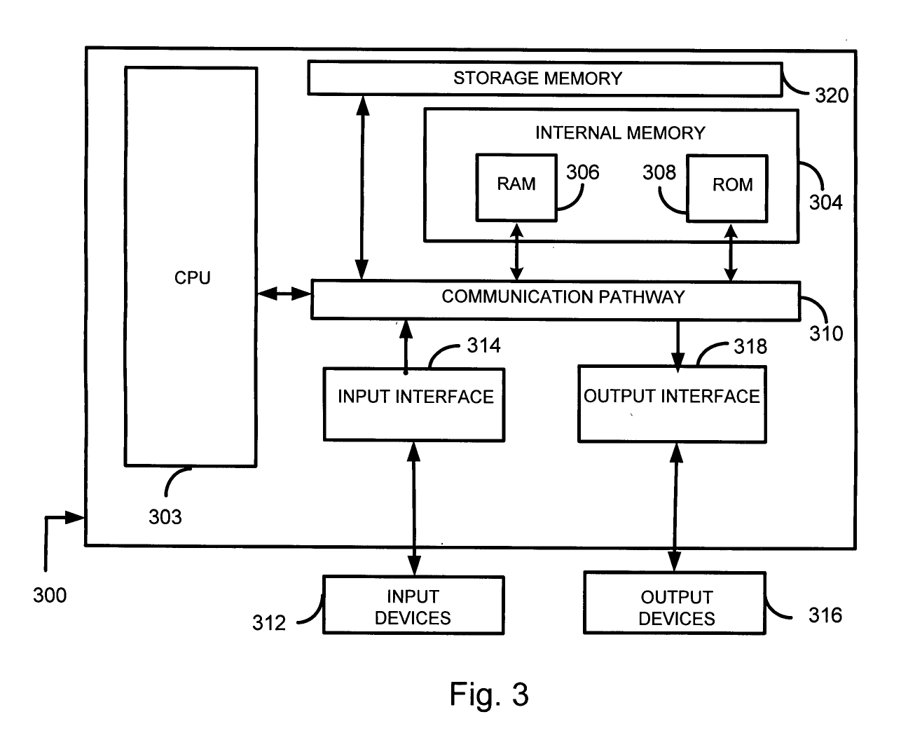

FIG. 3 displays a hardware architecture implementing the teachings of the present invention. The computer 300 may be used to implement the fast simulator 100, the translator 102, and the slow simulator 104 of FIG. 1. A central processing unit (CPU) 303 functions as the brain of the computer 300. Internal memory 304 is shown. The internal memory 304 includes short-term memory 306 and long-term memory 308. The short-term memory 306 may be a Random Access Memory (RAM) or a memory cache used for staging information. The long-term memory 308 may be a Read Only Memory (ROM) or an alternative form of memory used for storing information. Storage memory 320 may be any memory residing within the computer 300 other than internal memory 304. In one embodiment of the present invention, storage memory 320 is implemented with a hard drive. A communication pathway 310 is used to communicate information within computer 300. In addition, the communication pathway 310 may be connected to interfaces, which communicate information out of the computer 300 or receive information into the computer 300.

Input devices, such as tactile input device, joystick, keyboards, microphone, communications connections, or a mouse, are shown as 312. The input devices 312 interface with computer 300 through an input interface 314. Output devices, such as a monitor, speakers, communications connections, etc., are shown as 316. The output devices 316 communicate with computer 300 through an output interface 318.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A method of simulating, comprising the steps of:
modeling a circuit in a fast simulator and generating an output;
generating a translated output by translating the output; and
modeling the circuit in a slow simulator in response to generating a translated output.

2. A method of simulating as set forth in claim 1, wherein states associated with the circuit are modeled in the fast simulator as digital states.

3. A method of simulating as set forth in claim 1, wherein states associated with the circuit are modeled in the slow simulator as analog states.

4. A method of simulating as set forth in claim 1, wherein the translated output is implemented as initial conditions in the slow simulator.

5. A method of simulating as set forth in claim 1, wherein the modeling between the circuit in the fast simulator and the modeling of the circuit in the slow simulator is a one-to-one mapping.

6. A method of simulating as set forth in claim 1, further comprising the step of simulating the circuit in the slow simulator.

7. A method of simulating as set forth in claim 1, further comprising the step of simulating the circuit in the slow simulator until the circuit converges.

8. A method of simulating as set forth in claim 1, wherein the modeling of the circuit in the slow simulator is not a one-to-one mapping with the modeling in the fast simulator and the modeling in the slow simulator is performed at the most detailed level possible.

9. A method of simulating as set forth in claim 1, wherein the circuit includes cells with internal nodes and wherein the slow simulator is run until states associated with the internal nodes are determinate.

10. A method of simulating as set forth in claim 1, wherein the circuit includes cells with internal nodes and the internal nodes do not have exposure to the translated output and wherein the slow simulator is run until the slow simulator converges.

11. A method of simulating, comprising the steps of:
modeling a variable under investigation in a digital format;
generating an output by simulating the variable under investigation in the digital format;
translating the output to an analog format; and
modeling the variable under investigation in the analog format.

12. A method of simulating as set forth in claim 11, wherein the digital format further comprises representing the variable under investigation as a 0 or 1.

13. A method of simulating as set forth in claim 11, wherein the analog format further comprises representing the variable under investigation as a range of values.

14. A method of simulating as set forth in claim 11, wherein the step of modeling the variable under investigation in the digital format is performed until convergence is reached.

15. A method of simulating as set forth in claim 11, wherein the step of modeling the variable under investigation in the analog format is performed until convergence is reached.

16. A method of simulating as set forth in claim 11, wherein the step of modeling the variable under investigation in the digital format is performed at the most detailed level feasible.

17. A method of simulating as set forth in claim 11, wherein there is a one-to-one mapping between the variable under investigation in the digital format and the variable under investigation in the analog format.

18. A method of simulating as set forth in claim 11, wherein the step of simulating the variable under investigation in the digital format occurs faster than simulating the variable under investigation in the analog format.

19. A method of simulating as set forth in claim 11, wherein the step of simulating the variable under investigation in the analog format occurs slower than simulating the variable under investigation in the digital format.

20. A method of investigating a circuit variable, comprising the steps of:
simulating a digital model of a circuit thereby producing digital state information;
transforming the digital state information to analog state information; and
simulating an analog model of the circuit in response to transforming the digital state information to the analog state information.

21. A method of investigating a circuit variable as set forth in claim 20, wherein the digital model of the circuit further comprises representing states of variables in the circuit as either 0 or 1.

22. A method of investigating a circuit variable as set forth in claim 20, wherein the analog model of the circuit further comprises representing states of variables in the circuit as a range of values.
